(19) United States
(12) Patent Application Publication
(10) Pub. No.: US 2017/0323602 A1
(43) Pub. Date: Nov. 9, 2017

(54) A LOCAL DIMMING ALGORITHM AND DEVICE

(71) Applicant: UNIVERSITÄT DES SAARLANDES, Saarbrücken (DE)

(72) Inventors: Michael KRAUSE, Kirkel (DE); Alfred LOUIS, Saarbrücken (DE); Martin RIPLINGER, Püttlingen (DE); Chihao XU, Saabrücken (DE)

(73) Assignee: UNIVERSITÄT DES SAARLANDES, Saarbrücken (DE)

(21) Appl. No.: 15/525,430

(22) PCT Filed: Nov. 17, 2015
(86) PCT No.: PCT/EP2015/076873

§ 371 Date: May 9, 2017

(30) Foreign Application Priority Data
Nov. 17, 2014 (LU) LU 92 598

(51) Int. Cl. G09G 3/34; G06T 7/11

(52) U.S. Cl. CPC G09G 3/3426; G06T 7/11; G09G 2320/0626; G09G 2320/029

(57) ABSTRACT

A method for displaying an input frame on an edge-lit display lit by a multitude of light emitting diodes (LED) placed only along one or more sides of the display, comprises the steps of determining a brightness level for each LED of the multitude of LEDs, based on the input frame and an influence of each LED on the brightness of a pixel of the display, such that the brightness of the pixel essentially corresponds to the brightness level required by the input frame and an energy consumption of the LEDs and/or a difference between a resulting backlight and the input frame is essentially minimal, according to a given measure; dimming the light emitting diodes (LED), based on at least one input frame; and displaying the input frame on the display.

According to the invention, a relation between at least two different LEDs of the multi-tude of LEDs, in particular between their respective brightness levels, is taken into ac-count in the determination of the brightness levels.

The present invention relates to a method for locally dimming a LED-lit display and a related device.

### TECHNICAL BACKGROUND

Local dimming is a technique to reduce the power consumed by the backlight or luminance distribution generated by different LEDs. It acts on the different LEDs individually, in contrast to global dimming, which acts on all LEDs in the same manner.

An energy-efficient distribution of energy to the different LEDs of a particular display may be determined based on a model of the display. Two types of backlight technologies exist. The first is a direct lit display where the LEDs are distributed all over the back of the display. Mostly, they are placed in rows and columns as shown in FIG. 13. Therefore, the display can be divided into a plurality of partial regions and the light adjustment can be done in each region separately often followed by a luminance modification, to reduce a luminance difference of adjacent regions in a second step.

The second are edge lit displays. Here the LEDs are placed only on the edge of the display, mostly only along one edge but sometimes also along several edges of the device (see FIG. 15). In particular, the different regions cannot be treated separately anymore and the backlight in each pixel may be modeled as a combination of the influences of the different dimmed LEDs (see FIG. 16). Then, the sum of the power of all LEDs may be minimized under the restriction that all pixels achieve the necessary brightness in order to achieve an energy-efficient dimming level of each individual LED of the display.

### PRIOR ART

Different approaches have been proposed to find solutions to this problem in the context of local display dimming.

U.S. Pat. No. 8,411,116 discloses a sequential algorithm, the so-called SSC-algorithm, for solving a linear program in local dimming. It iterates over all pixels bᵢ of a smaller (condensed) image (e.g. 30×17) and increases the LED values x^{k} starting from an initial lower bound for the solution, e.g. (x⁰=0), and adds for all pixels an increment to x such that the desired brightness of the considered pixel is satisfied.

If αₖ:=max_{l=1, . . . , 510}{bₗ−aₗx^{k=1}} the maximum defect in iteration k with αₗ the row l of matrix A modelling the influences of the LEDs on the pixels and denote by j the row/component, where the maximum is attended, the iteration step for the SSC algorithm is given by

$${x}^{k} = {x}^{k - 1} + \frac{{α}_{k}}{{max}_{l = 1 , … , 16} {a}_{j , l}} \cdot {e}_{i} ,$$

where the unit vector eᵢ is chosen such that the maximum a_{j,i}=max_{l=1, . . . , 16}{a_{j,l}} is achieved for the index i. So, only the LED with the highest impact on the pixel under consideration will be increased in the update step. If this LED is already at 255, the LED with the second highest influence is taken and so on. Efficient hardware implementations, e.g. on FPGAs, are available.

A drawback of the linear programming model is the existence of more than one solution fulfilling the mathematical restriction. A naive approach using the standard simplex algorithm finds both solutions, depending on the start corner and the base entering strategy. The SSC algorithm finds, by construction, one particular solution. This leads to very good power management, whereas the solution often does not have the desired shape and a post processing procedure is needed.

It is therefore an object of the invention to provide an efficient method for dimming a display at reduced power consumption while maintaining a desired quality of the displayed image.

This object is achieved by a method and a device according to the independent claims. Advantageous embodiments are defined in the dependent claims.

The method may be executed in real time. In order to reduce the power consumption of an LED-lit display, the LEDs may be dimmed based on the image content of at least one input frame. The display may be an edge-lit display or a direct-lit display. In an edge-lit display, a multitude of light emitting diodes (LED) are placed only along one or more edges of the display.

The brightness level for each light emitting diode may be determined as a solution to an (extended) linear program. The solution may be obtained by applying a variant of a simplex algorithm, allowing to model further physical side conditions in the linear program. More particularly, the absolute value of a difference and/or a second or higher order difference quotient of a brightness level of neighboring light emitting diodes may be limited by an adjustable upper bound in order to avoid spotlights in the display input frame. Furthermore, the brightness levels of light emitting diodes may be calculated, such that the generated backlight or luminance distribution is aligned with the image itself, i.e. the absolute value of the difference between both is simultaneously minimized.

According to one aspect of the invention, the input frame may be condensed to a smaller frame size before determining the brightness of the light emitting diodes for dimming. The input frame may be condensed, as described e.g. in U.S. Pat. No. 8,687,028 B2 by dividing the input frame into regions and using aggregate brightness values for all pixels within a region, e.g. mean or maximum. The brightness may be determined by taking solutions from previous frames into account.

In a sequence of input frames, the solutions may be temporally smoothed. Smoothing may be achieved by using the weighted average of previous solutions and a simultaneous satisfaction of all brightness restrictions in every frame. The solution for the current frame may receive the largest weight. According to one aspect of the invention, only solutions for the same scene may be used. The method may comprise a step of detecting a scene cut.

A particular advantage of the invention is that it lends itself to parallel execution, leading to a significant increase in computational efficiency.

### BRIEF DESCRIPTION OF THE FIGURES

These and other aspects and advantages of the present invention will become more apparent when studying the following detailed description of various embodiments of the invention, in connection with the annexed drawing, in which

FIG. 1 shows a schematic flowchart of a local dimming method according to a first embodiment of the invention;

FIG. 2 shows a schematic flowchart of a method for finding a solution to the linear program according to an embodiment of the invention;

FIG. 3 shows the influences of four different LEDs of an edge-lit display on the illumination of the same;

FIG. 4 shows an example of spotlights avoided by a further embodiment of a method according to the invention;

FIG. 5 shows the results of comparing the method of the present invention according to one embodiment with the SSC-algorithm;

FIG. 6 shows results of a method according to one embodiment of the invention applied to the sample image (a) of FIG. 5 and comparisons to other methods;

FIG. 7 shows results of applying an embodiment of the inventive method to a second test image and comparisons with other methods;

FIG. 8 shows a schematic flowchart of a local dimming method according to a further embodiment of the invention;

FIG. 9 shows results of applying the method shown in FIG. 8 to a first example movie;

FIG. 10 shows the results for frame 380 of the first example movie, when using the simplex method of the invention;

FIG. 11 shows results of applying the method shown in FIG. 8 to a second example movie; and

FIG. 12 shows results of applying the inventive method to two different movies.

FIG. 13 is a diagram showing the schematic setting of a direct lit display.

FIG. 14 is a diagram showing the schematic setting of an edge lit display.

FIG. 15 is a diagram showing the schematic setting of another edge lit display.

FIG. 16 outlines why the backlight in each pixel may be modeled as a combination of the influences of the different dimmed LEDs.

FIG. 17 is a diagram showing how the image can be divided in several regions to condense the input frame to a smaller size.

### DETAILED DESCRIPTION

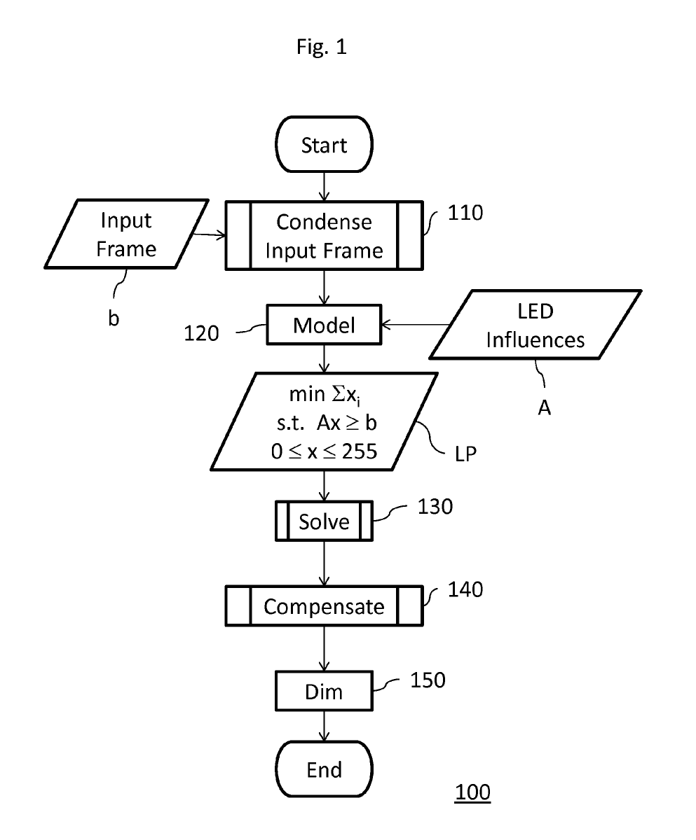

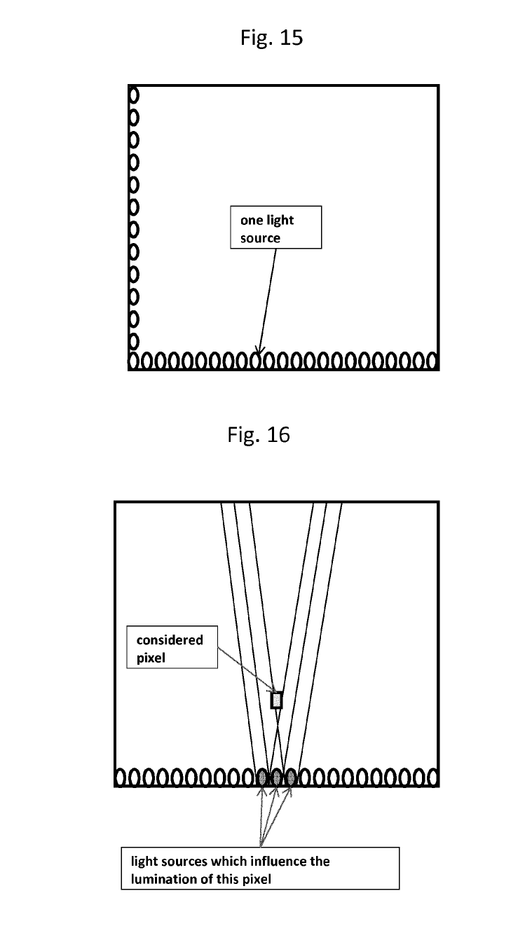

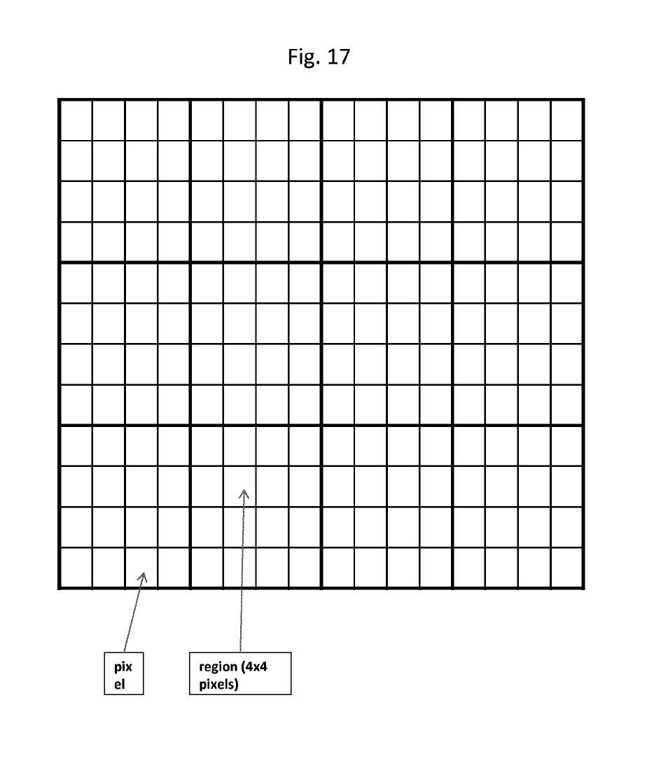

FIG. 1 shows a schematic flowchart of a method 100 according to a first embodiment of the invention. In an optional and preliminary step 110, the size of an input frame b may be condensed, e.g. from 1920×1080 to a smaller size like 30×17. In step 120, the condensed input frame b and a model for the influences of the LEDs on the backlight or luminance distribution are used to formulate a linear program LP. The matrix A models the influence of the different LEDs on the backlight of each pixel of a display. As can be seen in FIG. 15, for most of the pixels several LEDs influence their backlight and this influence depends mostly on the distance between the pixel and the LED if the pixel is in the flare of the LED. This flare broadens starting from the LED itself, while its intensity decreases. The linear program which gives an energy efficient solution x as a superposition of the influences of the different LEDs is given by:

$$min {\sum }_{i}^{ } {x}_{i}$$

$$s . t . Ax \geq b , \\ 0 \leq x \leq 255.$$

The matrix A is the matrix containing the influences aₖ as rows, b represents the input frame and x the energies of the different LEDs of the display. In other words, a solution vector x represents an energy-efficient distribution of brightness levels among the different LEDs. The power of one individual LED xᵢ can be between zero (OFF) and 255 (MAXIMUM ON). In this particular embodiment, a total of 16 LEDs is assumed, a generalization to a higher number of LEDs is straightforward. Furthermore, the image is condensed to a 30×17 image, i.e. in total 510 pixels. More specifically, the input frame is divided into rectangular regions (e.g. ca 64×64 pixels for a full hd picture) and only one aggregate brightness value (e.g. mean, maximum) of all pixels for each region leads to this 30×17 image (see also FIG. 16 for a schematic figure).

In step 130, a solution to the linear program LP is found using a variant of the simplex algorithm by inspecting the corners of the feasible region. More specifically, the simplex algorithm walks along the edges of the solution polytope to corners with decreasing objective values. The minimum value is reached or an unbounded edge is visited, concluding that the problem has no solution. The simplex algorithm always terminates since the number of vertices in the polytope is finite. Since the objective function is decreasing from iteration to iteration, one can choose an upper bound for the number of iterations to ensure that the calculation time does not exceed the given calculation time. Then, only an approximation of the solution is obtained.

In step 140, the reduced backlight may be compensated by higher TFT values if necessary, thus receiving the required brightness in each RGB pixel. The solution x found is then used for dimming the LEDs of the display in step 150. Dimming means setting the brightness levels of the LEDs according to the components of the vector x. As the solution x is the minimum power solution or at least an approximation thereof, the dimming algorithm is suitable for reducing the power consumption of the display.

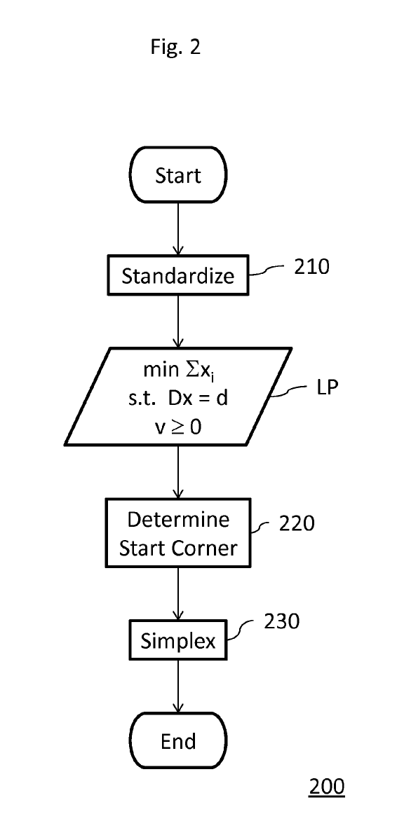

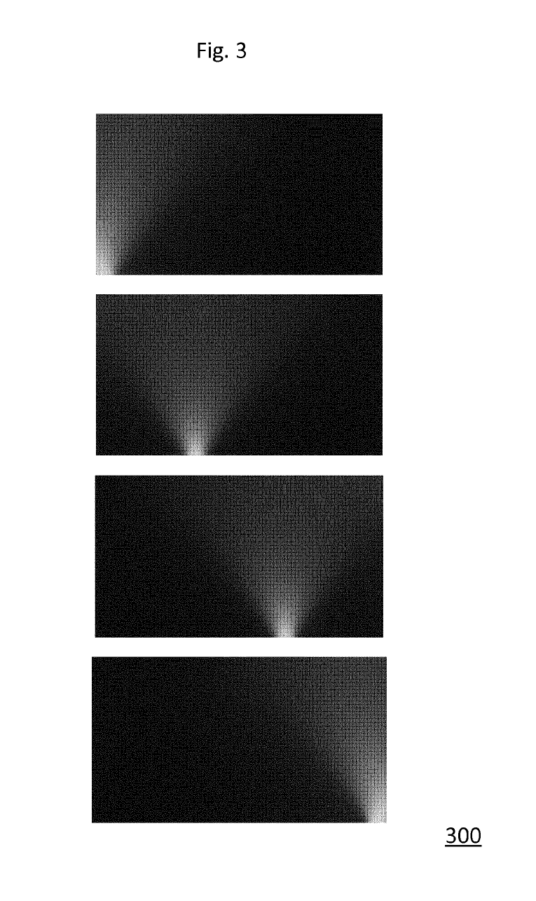

FIG. 2 shows a schematic flowchart of a method 200 for finding a solution to the linear program defined in modeling step 120, according to an embodiment of the invention

In step 210, the linear program is converted into standard form by introducing slack variables y and z:

$$min {\sum }_{i = 1}^{16} {x}_{i}$$

$$s . t . Dv = d , D ∈ {ℜ}^{526 \times 542}$$

$$v \geq 0.$$

In step 220, a starting corner for the application of the simplex algorithm is determined. According to the invention, the base B is chosen as

$$B = ( \begin{matrix}y \\ x\end{matrix} ) .$$

Then, the basis matrix

$${D}_{B} = ( \begin{matrix}- {Id}_{510 \times 510} & {A}_{510 \times 16} \\ {0}_{16 \times 510} & {Id}_{16 \times 16}\end{matrix} )$$

containing the last two columns of D is inverted. Since D_{b}=D_{B}⁻¹, normalization of the rows of A to one has been used, that is

A_{510×16}·255₁₆=255₅₁₀,

the reduced costs are calculated by

zᵣ=c^{T}−c_{B}^{T}(D_{B}⁻¹D)=(−1₁₆,0₅₁₀,0₁₆).

Hence, the basis chosen according to the invention leads to the following initial tableau with a particularly simple and efficient structure:

| B | z₁₆ | y₅₁₀ | x₁₆ | v_{B} |
|---|---|---|---|---|
| y₅₁₀ | A_{510×16} | Id_{510×510} | 0_{510×16} | 255₅₁₀ − b₅₁₀ |
| x₁₆ | Id_{16×16} | 0_{16×510} | Id_{16×16} | 255₁₆ |
| | −1₁₆ | 0₅₁₀ | 0₁₆ | −16·255 |

The variables on the left column give the basis B. The variables on the top row are all variables of the system; the matrix in the middle is the matrix the simplex algorithm is starting with. The last row lists the shadow costs, which are of importance for choosing the entering variable. The current negative value of the function to be minimized is depicted on the bottom right. At last, the column on the right side gives the values of the current base variables, while the values of the non-base variables are zero.

In step 230, the initial tableau obtained in step 220 is then used as a starting point for the application of the simplex algorithm.

In an improved embodiment of the invention, smooth solutions in which an intensity of two nearby LEDs does not vary more than an appropriate value may be achieved by including the following additional inequalities into the model, which have to be satisfied by a solution:

|xᵢ−xᵢ₊₁|≦c, i=1, . . . , 15,

where c is the maximum brightness value by which two nearby LEDs are allowed to differ.

Solving the absolute value leads to

xᵢ−xᵢ₊₁≦c, i=1, . . . , 15.

−(xᵢ−xᵢ₊₁)≦c, i=1, . . . , 15.

Finally, one has to introduce slack variables, leading to 30 new lines in the system matrix which is now given by

$$\underbrace{( \begin{matrix}{0}_{510 \times 16} & - {Id}_{510 \times 510} & {A}_{510 \times 16} & {0}_{510 \times 30} \\ {Id}_{16 \times 16} & {0}_{16 \times 510} & {Id}_{16 \times 16} & {0}_{16 \times 30} \\ {0}_{30 \times 16} & {0}_{30 \times 510} & {C}_{30 \times 16} & {Id}_{30 \times 30}\end{matrix} )}_{= {D}^{s}} \cdot \underbrace{( \begin{matrix}{z}_{16} \\ {y}_{510} \\ {x}_{16} \\ {s}_{30}\end{matrix} )}_{= {v}^{s}} = \underbrace{( \begin{matrix}{b}_{510} \\ {255}_{16} \\ {c}_{30}\end{matrix} )}_{= {d}^{s}}$$

with

$$0 \leq {v}^{s} , C = ( \begin{matrix}E \\ - E\end{matrix} ) and E = ( \begin{matrix}1 & - 1 \\ 1 & - 1 \\ ⋮ & ⋮ \\ 1 & - 1\end{matrix} )$$

So, the following initial tableau is derived as:

| B | z₁₆ | y₅₁₀ | x₁₆ | s₃₀ | v_{B} |
|---|---|---|---|---|---|
| y₅₁₀ | A_{510×16} | Id_{510×510} | 0_{510×16} | 0_{510×30} | 255₅₁₀ − b₅₁₀ |
| x₁₆ | Id_{16×16} | 0_{16×510} | Id_{16×16} | 0_{16×30} | 255₁₆ |
| s₃₀ | −C_{30×16} | 0_{30×510} | 0_{30×16} | Id_{30×30} | c₃₀ |
| | −1₁₆ | 0₅₁₀ | 0₁₆ | 0₃₀ | −16·255 |

In fact, the simplex algorithm can be used as before, only the dimension of the linear program is slightly increased. Instead of 526×542, the system matrix has now the dimension 556×572. Fortunately, the non-basic indices of the start corner are again {1, . . . , 16}.

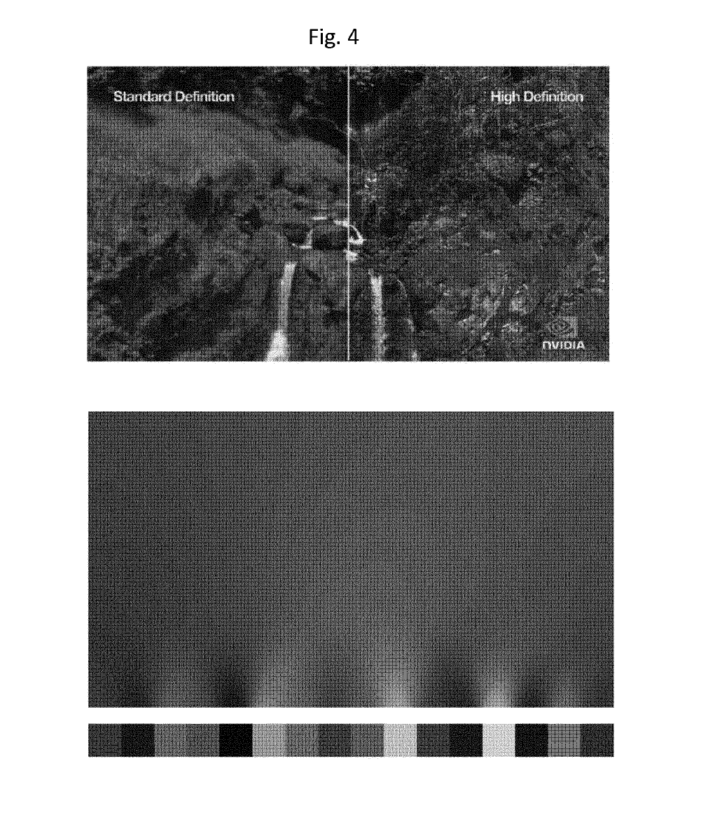

FIG. 4 shows an example of spotlights that may occur in connection with the energy-efficient dimming solutions discussed above. In this case, the values xᵢ₋₁ and xᵢ₊₁ are approximately zero for an index i ε {2, . . . , 15}, while xᵢ is almost 255 (or equal to c), or contrary, xᵢ≈0 and xₓ₋₁, xₓ₊₁≈255 (or equal to c). In both cases, the quantity |xᵢ₋₁−2xᵢ+xᵢ₊₁| will have a high value. In other words, the absolute values of the second order difference quotient of the function with values xᵢ exhibit a high value, since there is a sharp bending at xᵢ.

In order to reduce the occurrence of spotlights, the solution may therefore be further restricted by adding the following 28 additional requirements

xᵢ₋₁−2xᵢ+xᵢ₊₁≦d, i=2, . . . , 15,

−xᵢ₋₁+2xᵢ−xᵢ₊₁≦d, i=2, . . . , 15,

which are obtained by solving the absolute value, where the value d can be chosen by the user. To this end, one has to introduce slack variables, leading to 28 new lines in the system matrix which is now given by

$$\underbrace{( \begin{matrix}{0}_{510 \times 16} & - {Id}_{510 \times 510} & {A}_{510 \times 16} & {0}_{510 \times 30} & {0}_{510 \times 28} \\ {Id}_{16 \times 16} & {0}_{16 \times 510} & {Id}_{16 \times 16} & {0}_{16 \times 30} & {0}_{16 \times 28} \\ {0}_{30 \times 16} & {0}_{30 \times 510} & {C}_{30 \times 16} & {Id}_{30 \times 30} & {0}_{30 \times 28} \\ {0}_{28 \times 16} & {0}_{28 \times 510} & {F}_{28 \times 16} & {0}_{28 \times 30} & {Id}_{28 \times 28}\end{matrix} )}_{= {D}^{b}} \cdot \underbrace{( \begin{matrix}{z}_{16} \\ {y}_{510} \\ {x}_{16} \\ {s}_{30} \\ {t}_{28}\end{matrix} )}_{= {v}^{b}} = \underbrace{( \begin{matrix}{b}_{510} \\ {255}_{16} \\ {c}_{30} \\ {d}_{28}\end{matrix} )}_{= {d}^{b}}$$

with

$$0 \leq {v}^{b} , F = ( \begin{matrix}G \\ - G\end{matrix} ) and G = ( \begin{matrix}1 & - 2 & 1 \\ 1 & - 2 & 1 \\ ⋱ & ⋱ & ⋱ \\ 1 & - 2 & 1\end{matrix} ) .$$

Consequently, the initial tableau is derived as:

| B | z₁₆ | y₅₁₀ | x₁₆ | s₃₀ | t₂₈ | v_{B} |
|---|---|---|---|---|---|---|
| y₅₁₀ | A₅₁₀ₓ₁₆ | Id₅₁₀ₓ₅₁₀ | 0₅₁₀ₓ₁₆ | 0₅₁₀ₓ₃₀ | 0₅₁₀ₓ₂₈ | 255₅₁₀ − |
| | | | | | | b₅₁₀ |
| x₁₆ | Id₁₆ₓ₁₆ | 0₁₆ₓ₅₁₀ | Id₁₆ₓ₁₆ | 0₁₆ₓ₃₀ | 0₁₆ₓ₂₈ | 255₁₆ |
| s₃₀ | −C₃₀ₓ₁₆ | 0₃₀ₓ₅₁₀ | 0₃₀ₓ₁₆ | Id₃₀ₓ₃₀ | 0₃₀ₓ₂₈ | c₃₀ |
| t₂₈ | F₂₈ₓ₁₆ | 0₂₈ₓ₅₁₀ | 0₂₈ₓ₁₆ | 0₂₈ₓ₃₀ | Id₂₈ₓ₂₈ | d₂₈ |
| | −1₁₆ | 0₅₁₀ | 0₁₆ | 0₃₀ | 0₂₈ | −16 · 255 |

It is also possible to use only a bound for the second order difference quotient without restricting the difference of two nearby LEDs or to work with higher order derivatives.

In a further embodiment of the invention, the backlight may be aligned simultaneously to the given image, enabling the user not only to calculate a local dimming solution with high power saving, but also with a high correlation of the image and the backlight in one step. In more detail, one is interested in solutions with a small slack variable vector y=Ax−b=|Ax−b|≧0. Since all components of A, the right hand side b as well as y are non-negative, the two aims are not contrary. The artificial slack variable y can now easily be used for the simultaneous alignment of the backlight with the image. The objective function Σᵢ₌₁¹⁶ xᵢ of the previous embodiment is replaced by

$${\sum }_{i = 1}^{16} {x}_{i} + λ {\sum }_{i = 1}^{510} {y}_{i} ,$$

where the parameter λ>0 is used to balance the two aims. Let λ₅₁₀ be the 510×1 vector, where every component has the value λ. The reduced costs for the new objective function are calculated as follows:

zᵣ=c^{T}−c_{B}^{T}(D_{B}⁻¹D).

For the extended models, one obtains similar reduced costs. They are of the form

$${z}_{r} = ( \begin{matrix}- λ {\overline{a}}_{1} - 1 \\ ⋮ \\ - λ {\overline{a}}_{16} - 1 \\ {0}_{k}\end{matrix} ) ,$$

where k=556 or k=584, respectively and where āᵢ, i=1, . . . 16 is the sum over the i-th column of A.

Obviously, it is also possible to introduce different weights λᵢ for the individual pixels

$${\sum }_{i = 1}^{16} {x}_{i} + λ {\sum }_{i = 1}^{510} {λ}_{i} {y}_{i} ,$$

leading to similar results. Only if all LEDs have a similar impact on the backlight, i.e. a̅ᵢ̅ has similar values for all i, similar results for the new and the old objective function may be expected.

The strategy for selecting the entering variable for the simplex method has essential influence on the number of iterations and therefore on the computational time.

Independent of the additional requirements, the number of non-basic variables is 16. In the initial tableau, these are the slack variables z₁₆ which are used to guarantee the inequality x≦255. From view of the claim, namely minimizing the sum of xᵢ,i=1, . . . , 16, it is clear that it is desirable that these indices enter the basis, since it holds xᵢ=255−zᵢ,i=1, . . . , 16. The other indices only ensure that the requirement Ax≧b is valid. So, the idea is to prefer the first 16 variables in the basis selection step.

According to an embodiment of the invention, the nested Dantzig rule of Pan (Pan, Ping-Qi: Efficient nested pricing in the simplex algorithm. In: Operations research letters, 36, 2008, No. 3, Page 308-313) may be used for this purpose: at the beginning, set J=N and choose ε>0. Here, N denotes the non-basic indices.

1) Calculate Ĵ={j|cⱼ<−ε, j ε J}. If Ĵ≠Ø, choose q=argmin {zⱼ|j ε Ĵ} and set J=Ĵ\q, otherwise proceed with step 2.

2) Calculate \tilde{J}={j|cⱼ<−ε, j ε N\J}. If \tilde{J}≠Ø, choose q=argmin {zⱼ|j ε \tilde{J}} and set J=\tilde{J}\q, otherwise proceed with step 3.

3) An optimal corner is found.

In fact, instead of the Dantzig rule, other methods as Devex can be used in this nested scheme. But it turns out, that the Dantzig rule is preferable.

If a pixel of an image is very bright, then the LEDs which have a big impact on this pixel must have a high value, i.e. they have to be basis variables. In other words, these indices should be removed from the initial set J. In more details, let \tilde{b}ⱼ the vector of the components of b, which represents the image brightness above the LED with index j.

1. Let u≈255 and M :={j ε {1, . . . , 16}|max{\tilde{b}ⱼ}≧u}, then set J=N\M.

2. One can also extend this idea by considering more components of b which have effect on the value of xⱼ. For this, consider the image b as matrix B_{k,l},k=1, . . . , \tilde{k}, l=1, . . . , \tilde{l}. Then, define

$$M := \{ j ∈ \{ 1 , … , 16 \} \vert {\sum }_{j = 0}^{\tilde{k} - 1} {\sum }_{l = - j}^{j} {c}_{jl} {B}_{\tilde{k - j , l}} \geq \tilde{u} \}$$

with coefficients c_{j:} decreasing in j (for fixed l) and symmetric in l and a chosen upper bound ũ. Here, we set B_{i,j}:=0 if the indices exceed the domain of definition. The selection c₀₀=1 and zero otherwise clearly corresponds to case 1. Another possible selection is

$${c}_{jl} = \frac{1}{( l + 1 ) ( j + 1 )} .$$

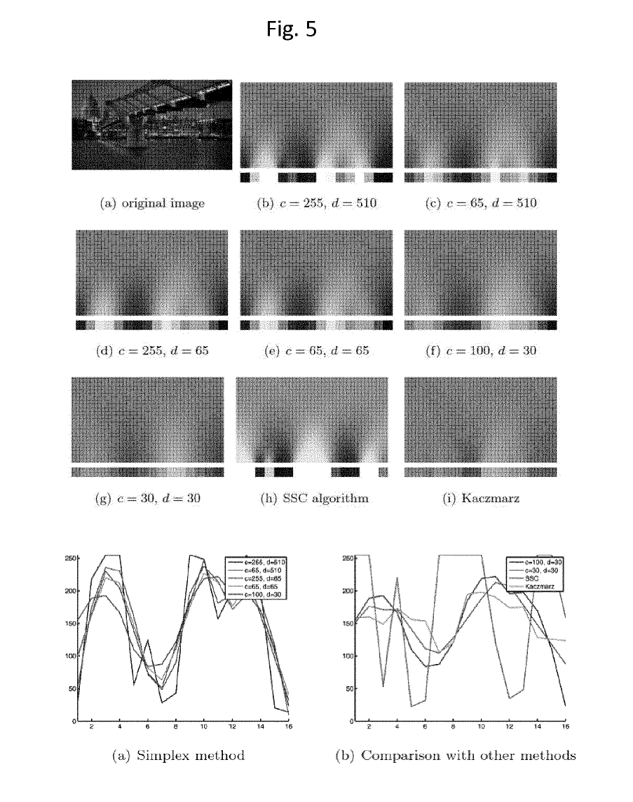

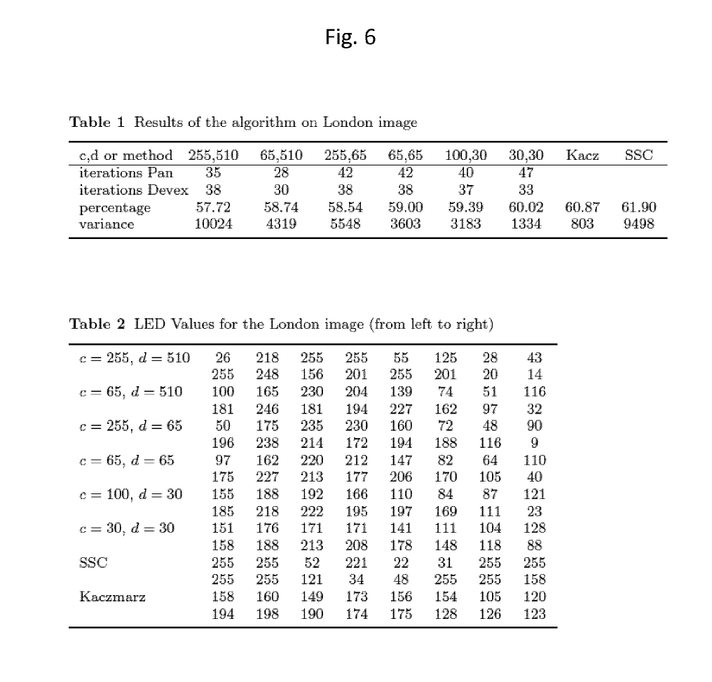

FIG. 5 shows the results of the simplex method for different parameters and the SSC algorithm on the LED values for the London picture. The white/gray images show the LED backlight without displaying the processed images. Table 2 of FIG. 6 contains the exact values of the LED values for the different algorithms.

For this picture, it is obvious that the two LEDs on the left are quite bright for the SSC algorithm, which is not case for any simplex solution. A similar but weaker effect is visible on the right hand side.

This is probably the main reason why the simplex algorithm is capable of saving up to 4 percent in comparison to the SSC method. The effect of different c and d can be seen in FIG. 6. For c=255 and d=510, i.e. no additional restrictions, the results of the simplex and SSC algorithm have a similar shape, high jumps between neighboring LEDs.

Decreasing the parameter d smoothes the solution towards the result of the Kaczmarz algorithm. This is also visible in a decreasing variance, see table 2. While there appear bright and dark spots in FIGS. 5(b) and (h), this is almost not the case in 5(f) and (g).

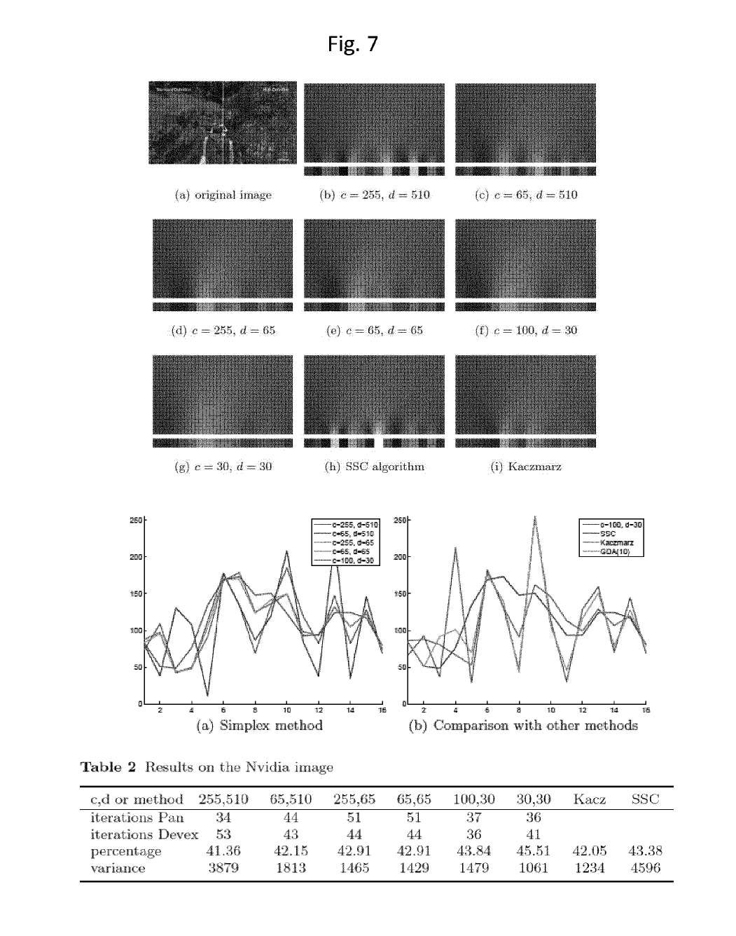

FIG. 7(a) shows a nature picture (originating from Nvidia), where on the left and right high and standard definition are compared. Again, the results of the SSC (FIG. 7(h)) and the unconstrained simplex algorithms (FIG. 7(b)) are very jumpy, and the power of some LEDs are (almost) maximized. The results of the simplex method in the second row of FIG. 7(d)-(f) are nicely smooth with no spotlight artifacts. Furthermore, they show the shape of a mild hill in the middle, while it is more up and down in case of the Kaczmarz algorithm. The power saving for this picture varies about one percent. Looking at the number of iterations for the simplex method, one detects that the numbers of both rules, the Devex and the nested Dantzig rule of Pan, are comparable. It seems that the Pan rule has a slightly smaller number of iterations when the restrictions are soft, while for strong restrictions, i.e. small c and/or d, the Devex rule needs less iterations.

All algorithms were implemented in Matlab and a desktop computer with an Intel E8400 CPU with 4 GB memory was used to measure the run-time. The basis matrix for the simplex method is very sparse, which should be taken into account for the implementation. Of course it is also possible to make use of revised simplex method or the dual simplex method for the implementation.

To obtain the right hand side b from these pictures, they were condensed to 30×17 and the gamma correction with γ=1.8 is performed. Furthermore, to improve the power consumption for all algorithms, the influence matrix A has been thresholded with a value of 0.05. So, very small entries of that matrix have not been taken into account. Note, that the matrix is not row-stochastic anymore, especially Σⱼa_{i,j}≦1, leading to small modifications of the formulas.

The presented results of the different methods stay valid no matter how the threshold is chosen.

According to the invention, the ability to warm-start the simplex method may be used when applying the local dimming method to displaying sequences of similar images shown on a screen.

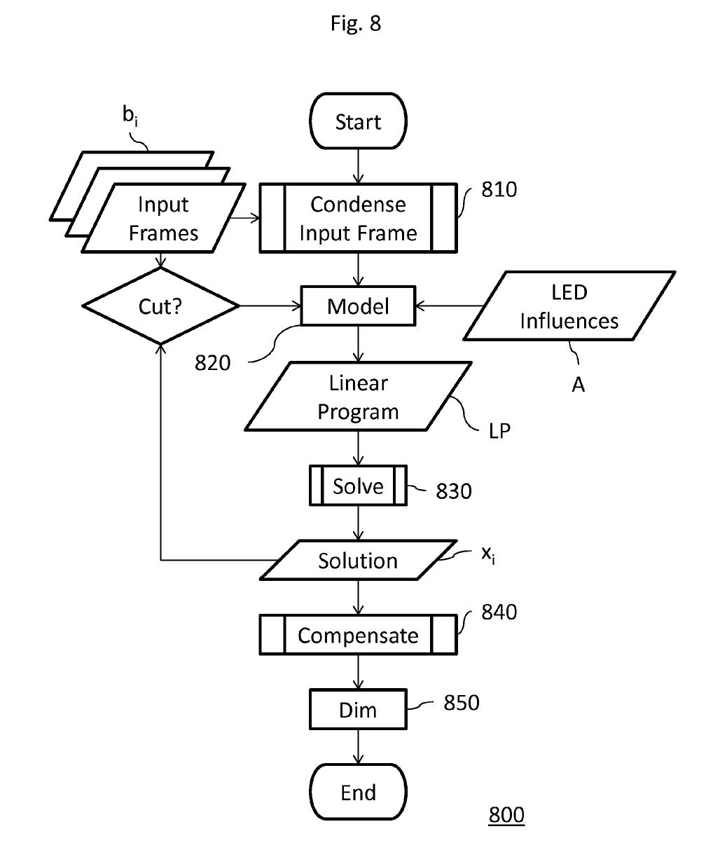

FIG. 8 shows a local dimming method according to a further embodiment of the invention, working on input frames bᵢ. As in FIG. 1, the input frames are condensed in step 810. The condensed input frame is then used in the modeling step 820 to create a linear program LP. The linear program LP now not only depends on the LED influences A, but also on previous solution(s) x(t), if there is no cut in the image sequence, that is if the input frames do not differ significantly. In a practical application, one should use the warmstart-strategy only if two frames are similar, for example if the maximum or the mean of the difference of the two frames is below a chosen value.

The linear program then incorporates also solutions for the previous frames. Again, this linear program LP is solved in step 830. The simplex method for the current frame starts with the basic indices from the optimal basis of the last frame.

The procedure is the same no matter if additional restrictions, e.g. the limitation of the second order derivative, are considered or not. The matrix in the initial tableau D¹ has in all cases the sparse structure (X Id), where X s a matrix of dimension n×16 (n is 526, 556 or 584).

Let B be the set of the basic indices for the optimal solution of frame i−1. For example, if B is the set from 17 to n, then this is our initial corner from the former sections and nothing has to be done. The right hand side b is always greater than or equal to zero. If B is an arbitrary basic set with n−16 different elements between 1 and n, B̅:=D¹(B;:) is the corresponding basis matrix. One may calculate x by solving B̅x=b, where b is the right hand side of the initial tableau for frame i. If all components of x are positive, a start corner for the simplex is found. Otherwise, one solves the following linear program with the simplex method to obtain a feasible corner. First, define V={j|xⱼ<0} and set

$${\overline{c}}_{j} = \{ \begin{matrix}- 1 , & if j ∈ V \\ 0 , & otherwise\end{matrix} .$$

Then, the linear program is given by

minc̅^{T} x

s.t. D¹x=r

xᵢ≧0,i ∉V,

where r is right hand side of the corresponding initial tableau.

Furthermore, it is reasonable to allow only a small number of iterations to solve phase 1 of the simplex algorithm. If no solution can be found, one may proceed with the standard basis indices.

If a cut occurs in the image sequence, i.e. two frames are not similar, for example if the maximum or the mean of the difference of the two frames is greater than a chosen value, phase 1 should be skipped and the standard basis indices {17, 18, . . . , n} be used instead.

Finally, the found solution is used to dim the LEDs of the screen in step 850, including an optional compensation step 840.

In another embodiment of the invention, the simplex method can also be tuned for motion pictures. Therefore, let t be the actual frame and assume that a continuous scene is shown on the display, i.e. the solution x(t) should be close to the one of the last frame(s). Let M denote the moving average over the last l frames which should have impact on the solution of the current frame t, i.e

$$M = M ( t ) = {\sum }_{i = 1}^{l} {w}_{i} x ( t - i ) ,$$

where the (non negative) weights wᵢ sum up to one. If the weights are fixed (and so M), the modified linear program looks as follows:

$$min {\sum }_{i} {x}_{i}$$

$$s . t . Ax \geq b , \\ \vert {x}_{i} - {x}_{i + 1} \vert \leq c , i = 1 , … , 15 , \\ \vert {x}_{i} - 2 {x}_{i + 1} + {x}_{i + 2} \vert \leq d , i = 1 , … , 14 , \\ M - e \leq x \leq M + f , e , f \geq 0 ,$$

where t is skipped to improve the notation. There exist two new parameter vectors e and f, controlling the deviance of the new solution from the moving average. The constraints M−e≧0 and M+f≦255 have to be satisfied to guarantee a feasible solution of the original problem. Furthermore, they must guarantee that there is a feasible point in the new minimization set.

The component eᵢ of e controls the maximum decrease of the LED i from the actual frame to the next one. According to the invention, this value can be chosen in a physically meaningful way, to avoid flickering artifacts. Let e^{max} be an appropriate upper bound for this, then the components of e may be defined as

eᵢ=min{e^{max},Mᵢ},

where Mᵢ denotes the i-th component of M.

So, it holds M−e≧0 for every component. The smaller e^{max} is chosen, the smaller the power saving will be. It takes longer, i.e. more frames, to reduce the backlight if the movie gets darker in these frames. For the determination of f, one may demand that f is a vector where every component has the same value, i.e. f=(f^{max}, . . . , f^{max})^{T}. To guarantee the existence of a feasible point, one makes use of

$$A ( M + f ) = AM + Af {\geq }^{!} b \\ ⇔ {( AM )}_{j} + {f}^{max} {‖ {a}_{j} ‖}_{1} {\geq }^{!} {b}_{j} {∀}_{j} \\ {f}^{max} \geq \frac{{b}_{j} - {( AM )}_{j}}{{‖ {a}_{j} ‖}_{1}} {∀}_{j}$$

Now, define

$${f}^{max} = {max}_{j} \{ \frac{{b}_{j} - {( AM )}_{j}}{{‖ {a}_{j} ‖}_{1}} \}$$

and finally, set

ƒᵢ=min{f^{max},255−M},

where ƒᵢ are the components of f. By doing this, it holds M+f≦255 and A(M+f)≧b. So, M+f is a feasible point of the optimization problem (21) by construction.

In order to derive the new initial tableau, slack variables z⁺, z⁻≧0 and y≧0 are introduced such that

Ax=y=b, x+z⁺=M+f and x−z⁻=M−e.

The resulting initial tableau is then:

| B | z⁺ | y | z⁻ | x | s | t | v_{B} |
|---|---|---|---|---|---|---|---|
| y₅₁₀ | A | Id | 0 | 0 | 0 | 0 | A(M + f) − b |
| z₁₆ | Id | 0 | Id | 0 | 0 | 0 | e + f |
| x₁₆ | Id | 0 | 0 | Id | 0 | 0 | M + f |
| s₃₀ | −C | 0 | 0 | 0 | Id | 0 | −C(M + f) + c₃₀ |
| t₂₈ | −F | 0 | 0 | 0 | 0 | Id | −F(M + f) + d₂₈ |
| | −1₁₆ | 0₅₁₀ | 0₁₆ | 0₁₆ | 0₃₀ | 0₂₈ | −16 · 255 |

The algorithm for image sequences was implemented in Matlab on a personal computer having an Intel CPU E8400 and 4 GB main storage and tested for two different movies. To obtain the right hand side b(t) of frame t, the frame is condensed to an image of size 30×17 (by taking the mean value) and the gamma correction with γ=1.8 is performed. Furthermore, to improve the power consumption for all algorithms, the influence matrix A has been thresholded with a value of 0.05. So, if a LED has almost no impact to the illumination of a pixel, this influence is neglected. For example, a LED on the left is not taken into account for a pixel positioned at the bottom right. The results of the methods are similar for other threshold values. Furthermore, l=5 is used and the weights w=[0.5, 0.2, 0.1, 0.1, 0.1] for the result averaging as well as for the calculation of M.

As a first example, the trailer of “Pirates of the Caribbean: At World's End” was chosen as a test movie, being a very fast film with a lot of short scenes and cuts. The movie has 3458 frames.

The scene detector, which easily reacts to a large change between the actual and the former frame, counted 91 cuts within this trailer.

FIG. 9 shows the results of the proposed simplex method for different values of c and d. The 16 LEDs are placed on the x-axis, and a sample of 150 consecutive frames between frame 250 and 400 is shown on the y-axis. The colorbar goes from 0 to 255. In the unrestricted case, FIG. 9(a), high jumps between neighbored LEDs are visible, especial in the first frames between LED 11, 12 and 13, but also around frame 350 for LED 11. The stronger the restrictions are chosen, the more the LEDs tend to be uniform distributed and neighbored LEDs do not differ as much as before. For example, the high value of LED 11 around frame 350 does not exist anymore in these solutions.

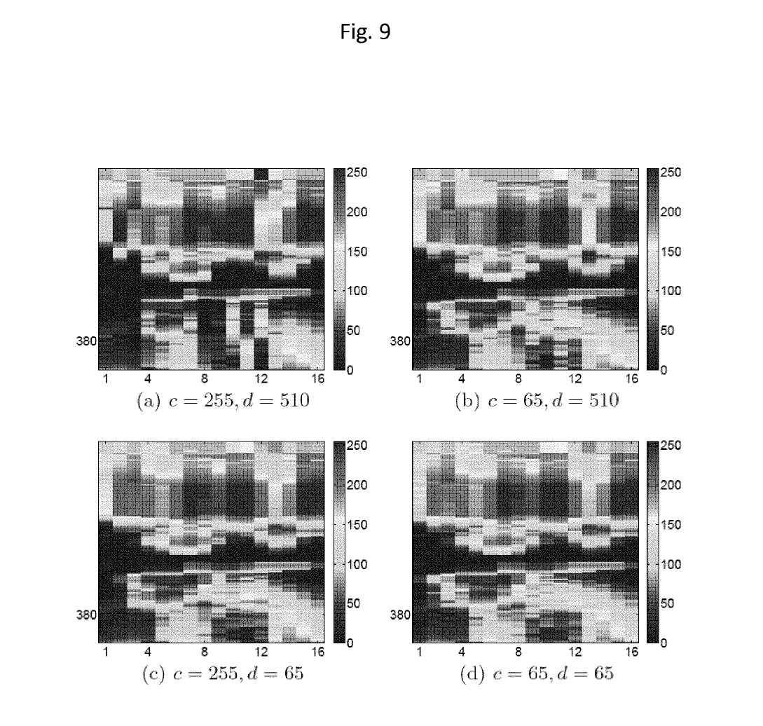

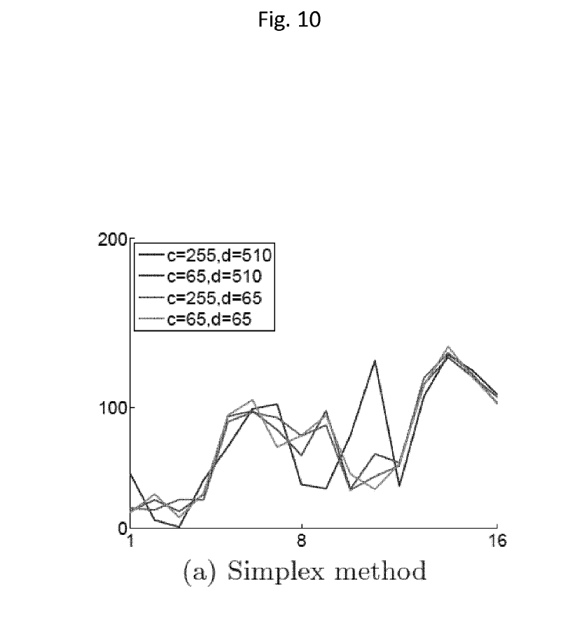

FIG. 10 shows the results for frame 380 in details. The stronger the restrictions, the smoother the results and the smaller the jumps are between the LEDs.

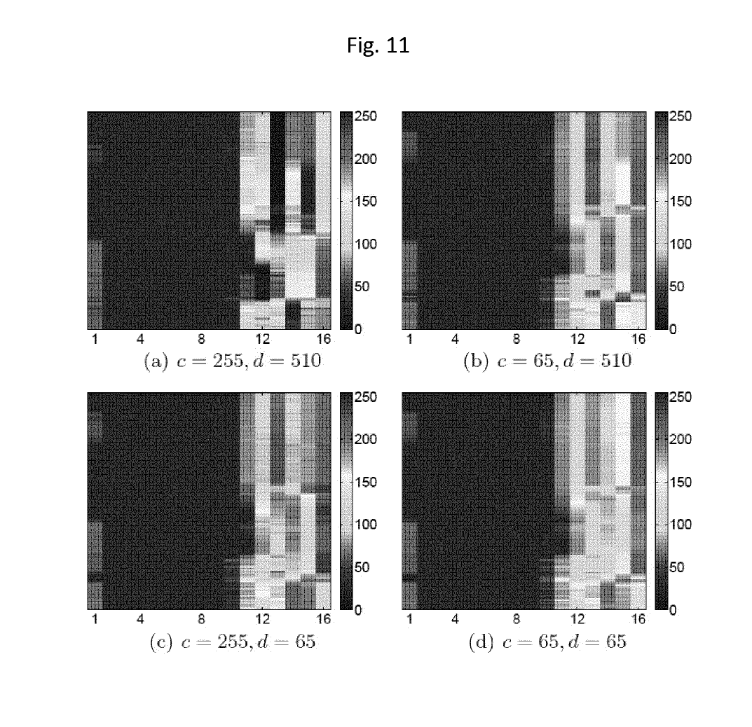

FIG. 11 shows results of applying the method shown in FIG. 8, applied to a second example, namely a movie of a speech of Barak Obama about ‘a more perfect union’. The movie has 33414 frames and can be found at http://www.youtube.com/watch?v=zrp-v2tHaDo. In the unrestricted case of the simplex method, FIG. 11(a), the LEDs greater 10 have very different values, which also change quite much during the movie. The stronger the restrictions are chosen, the more the LEDs tend to be uniformly distributed and also regularization in time is visible.

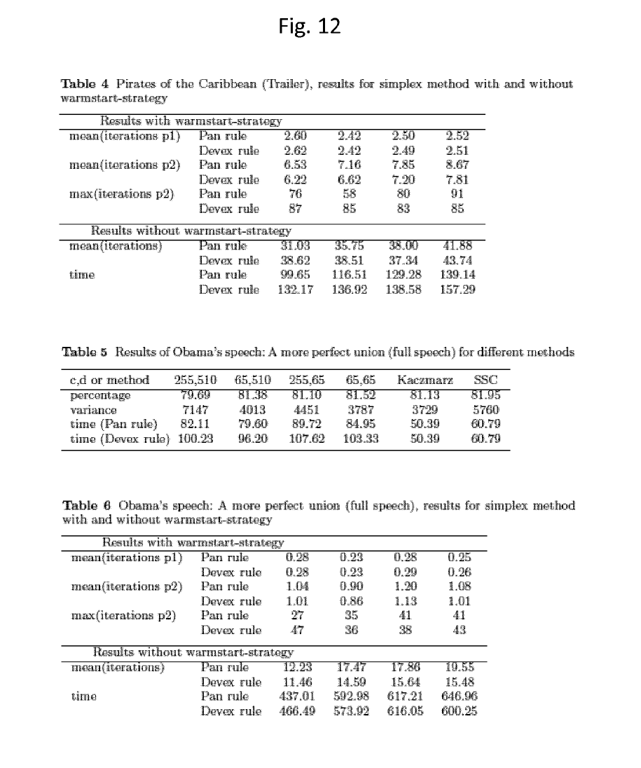

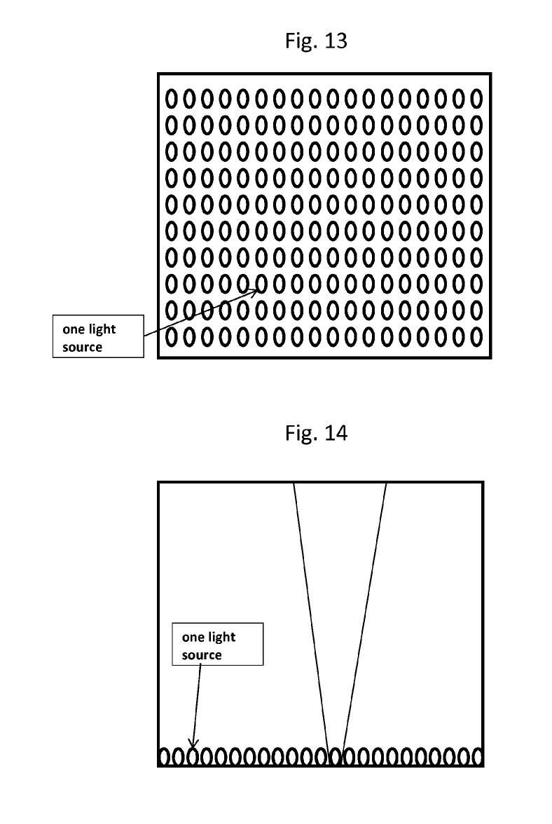

FIG. 12 shows results of applying the inventive method to the two different movies mentioned above.

1. A method for displaying an input frame on an edge-lit display lit by a multitude of light emitting diodes (LEDs) placed only along one or more edges of the display, the method comprising:
determining a brightness level for each LED of the multitude of LEDs, based on the input frame and an influence of each LED on the brightness of a pixel of the display, such that the brightness of the pixel essentially corresponds to the brightness level required by the input frame and an energy consumption of the LEDs and/or a difference between a resulting backlight and the input frame is essentially minimal, according to a given measure;
dimming the light emitting diodes (LEDs), based on the determined bright-ness levels; and
displaying the input frame on the display,
characterized in that
a relation between at least two different LEDs of the multitude of LEDs, in particular between their respective brightness levels, is taken into account in the determination of the brightness levels.

2. The method according to claim 1, characterized in that a difference in a brightness levels of neighboring light emitting diodes is limited by an adjustable upper bound (c).

3. The method according to claim 1, characterized in that a second or higher order difference quotient of brightness levels of neighboring light emitting diodes is limited by an adjustable upper bound (d).

4. The method according to claim 1, characterized in that a brightness level for each light emitting diode is determined as a solution to a linear program.

5. The method according to claim 1, characterized in that the backlight is simultaneously aligned to the image.

6. The method according to claim 1, characterized in that the input frame is first condensed to a smaller size by dividing the input frame into regions and using aggregate brightness values for all pixels within a region.

7. The method according to claim 4, characterized in that the brightness is determined by taking solutions from previous frames into account.

8. The method according to claim 1, characterized in that individual steps in determining the brightness levels for the LEDs are executed in parallel.

9. The method according to claim 4, characterized in that the solution is obtained by applying a simplex algorithm.

10. The method according to claim 9, characterized in that a starting corner for the simplex algorithm is determined based on a difference between a maximal brightness (255) vector and the brightnesses (b) required by the input frame.

11. The method according to claim 10, characterized in that an entering variable is selected according to the nested Dantzig rule.

12. The method according to claim 1, wherein the brightness of the pixel is adjusted by increasing a corresponding TFT value.

13. A method for displaying a sequence of input frames on an edge-lit display lit by a multitude of light emitting diodes (LED) placed only along one or more edges of the display, the method comprising:
determining a brightness level for each LED of the multitude of LEDs, based on the input frame and an influence of each LED on the brightness of a pixel of the display, such that the brightness of the pixel essentially corresponds to the brightness level required by the input frame and an energy consumption of the LEDs and/or a difference between a resulting backlight and the input frame is essentially minimal, according to a given measure;
dimming the light emitting diodes (LED), based on the determined bright-ness levels; and
displaying the sequence of input frames on the display,
characterized in that
a relation between at least two different LEDs of the multitude of LEDs, in particular between their respective brightness levels is taken into account in the determination of the brightness levels.

14. The method according to claim 13, characterized in that the step of determining the brightness level for each LED of the multitude of light emitting diodes (LED) is based on an input frame and the brightness levels of at least one previous input frame.

15. The method according to claim 14, further comprising:
testing, whether the input frame to be displayed and previous is input frames are homogenous, and
using an LED brightness level of a previous input frame for dimming the LEDs for the current input frame, if yes.

16. A device for displaying an input frame on an edge-lit display lit by a multitude of light emitting diodes (LED) placed only along one or more edges of the display, the device comprising:
a determining module for determining a brightness level for each LED of the multitude of LEDs, based on the input frame and an influence of each LED on the brightness of a pixel of the display, such that the brightness of the pixel essentially corresponds to the brightness level required by the input frame and an energy consumption of the LEDs and/or a difference between a resulting backlight and the input frame is essentially minimal, according to a given measure;
a dimming module for dimming the light emitting diodes (LED), based on the determined brightness levels;
a display for displaying the input frame on the display, and adapted to execute a method according to claim 1.
